(19) United States
(12) Patent Application Publication
(10) Pub. No.: US 2015/0069980 A1
(43) Pub. Date: Mar. 12, 2015

(54) CONVERTER IN DELTA CONFIGURATION

(71) Applicants: Herbert Gambach, Uttenreuth (DE); Dominik Schuster, Diespeck (DE)

(72) Inventors: Herbert Gambach, Uttenreuth (DE); Dominik Schuster, Diespeck (DE)

(73) Assignee: SIEMENS AKTIENGESELLSCHAFT, MUENCHEN (DE)

(21) Appl. No.: 14/365,118

(22) PCT Filed: Dec. 15, 2011
(86) PCT No.: PCT/EP2011/072903

§ 371 Date: Jun. 13, 2014

(51) Int. Cl. H02M 1/12; H02M 1/42

(52) U.S. Cl. CPC H02M 1/12; H02M 1/4208
USPC 323/207

(57) ABSTRACT

A converter for three-phase voltage has three electrically delta-connected series circuits. Each of the series circuits has at least two switching modules connected in series. A control device is connected to the switching modules and can drive the switching modules in such a way that branch currents with a fundamental frequency of the three-phase voltage and with at least one additional current harmonic flow in the series circuits. The additional current harmonic is dimensioned such that it flows in the series circuits of the converter and remains inside the converter.

The invention relates to a converter in delta configuration for a three-phase voltage. Converters with delta configuration can, for example, be used for the compensation of reactive power, harmonics and flicker.

A converter for a three-phase voltage is, for example, described in document “SVC PLUS: An MMC STATCOM for Network and Grid Access Applications” (M. Pereira et al., 2011 IEEE Trondheim Power Tech). This previously known converter is employed as a compensator.

During the operation of a converter with delta configuration employing the regulation and control methods known today, an energy pulsation arises in the converter branches of the converter.

The invention addresses the task of providing a converter with delta configuration in which the energy swing of this energy pulsation can be reduced in comparison with conventional converters.

This task is fulfilled according to the invention by a converter with the characteristics of patent claim 1. Advantageous embodiments of the converter of the invention are given in the dependent claims.

Accordingly, a converter is provided according to the invention with three delta-connected series circuits, each of which comprises at least two switching modules connected in series, and a control apparatus connected to the switching modules which control apparatus can operate the switching modules such that branch currents with the fundamental frequency of the three-phase voltage and with at least one additional current harmonic flow in the series circuits, wherein the additional current harmonic is dimensioned such that it flows in a closed loop in the series circuits of the converter, and remains within the converter.

A significant advantage of the converter of the invention consists in that in it—in contrast to previously known converters—the energy swing resulting from feeding in additional harmonic currents can be reduced. This calls for brief further explanation: in the quasi-stationary state, the total energy stored in the capacitors of each branch pulses around a mean branch energy that is a consequence of both the design and the control/regulation of the converter. Within each period, each branch of the converter thus exhibits a moment in time at which the total energy stored in the branch is a maximum, and is larger than its temporal mean. Equally, within each period of the mains voltage there is a moment in time at which the energy stored in the branch is a minimum, and is smaller than its temporal mean. The difference between the maximum and minimum branch energies, i.e. the energy swing, is given, if the quasi-stationary and symmetrical condition is considered, by the operating point of the converter. The additional harmonic currents provided according to the invention can reduce the energy swing in a simple and advantageous manner, without being able to appear outside or to cause interference, since according to the invention they flow in a closed loop, so that they are unable to leave the converter at its external terminals.

In contrast to other converters with bridge configuration, converters with delta configuration are not in general able to transmit or transform real power in stationary operation (apart from their own power losses). It is therefore considered advantageous if the converter is employed for compensating reactive power, harmonics and flicker. In other words, the converter preferably comprises a compensator, in particular a compensator for reactive power, harmonics or flicker, or an element of such a compensator.

Particularly preferably the converter is a cascaded full-bridge converter.

In respect of the construction of the converter, it is viewed as advantageous if the converter comprises a harmonic determination module which determines at least one additional current harmonic on the basis of the converter operating state at the time, wherein the additional current harmonic is dimensioned such that it flows in a closed loop in the series circuits of the converter and remains within the converter, and wherein the control apparatus operates the switching modules such that the at least one additional current harmonic determined by the harmonic determination module flows in a closed loop in the series circuits.

The magnitude and phase of the additional harmonic currents are preferably dimensioned such that the energy swing in each of the series circuits is smaller than without the additional harmonic currents.

Each of the switching modules preferably comprises at least four transistors and one capacitor.

Moreover, a method for the operation of a converter for a three-phase voltage with three delta-connected series circuits, each of which comprises at least two switching modules connected in series is considered as the invention.

According to the invention it is provided in respect of such a method that the switching modules are operated such that branch currents with the fundamental frequency of the three-phase voltage and with a specified magnitude and/or a specified waveform flow in the series circuits, on the basis of the converter operating state at the time, at least one additional current harmonic is determined, wherein the additional current harmonic is dimensioned such that it flows in a closed loop in the series circuits of the converter and remains inside the converter, and the switching modules are operated such that the at least one additional current harmonic determined at the time flows in a closed loop in the series circuits.

In respect of the advantages of the method of the invention, we refer to the advantages of the converter of the invention explained above, since the advantages of the converter of the invention correspond substantially to those of the method of the invention.

It is considered advantageous for the magnitude and phase of the additional harmonic currents to be dimensioned such that the energy swing in each of the series circuits is smaller than without the additional harmonic currents.

Preferably one or more harmonic currents, whose frequency corresponds to a multiple, divisible by three, of the fundamental or mains frequency of the three-phase voltage, are impressed onto the branch currents of the series circuits (R1, R2, R3).

It is also considered advantageous for one or more harmonic voltages to be impressed into the converter, whose frequency corresponds to a harmonic, divisible by three, of the fundamental or mains frequency of the three-phase voltage.

Particularly preferably, a compensation is performed with the converter, in particular a compensation for reactive power, harmonics or flicker.

The invention is explained in more detail below with reference to exemplary embodiments; these show as examples:

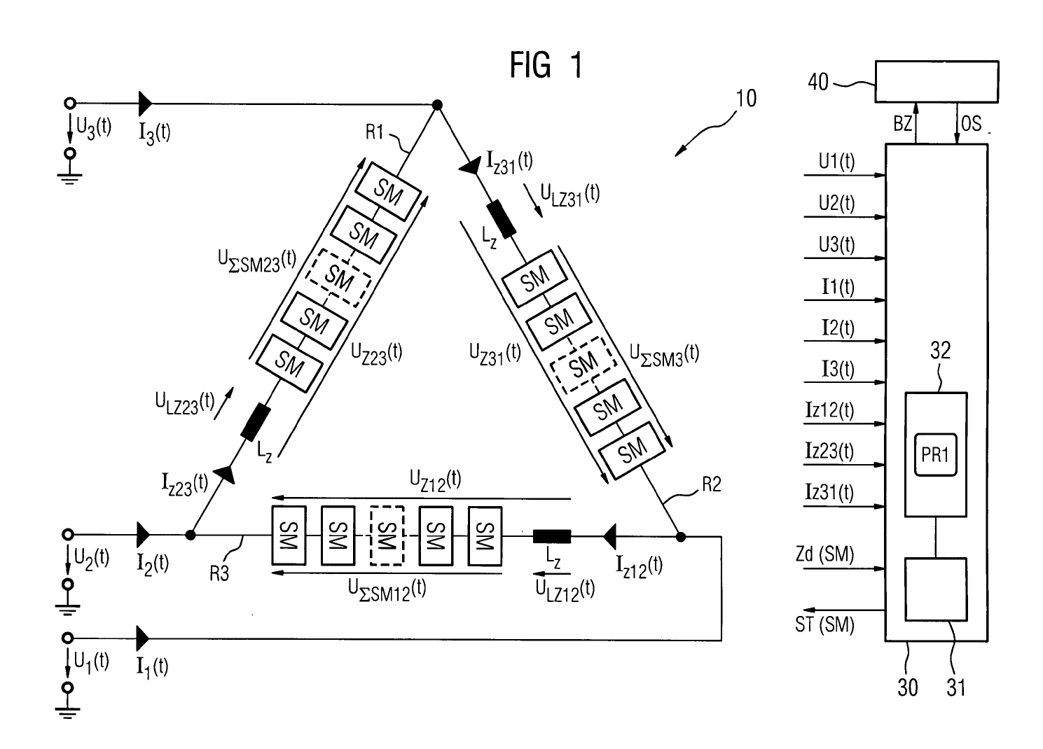

FIG. 1 a first exemplary embodiment for a converter according to the invention with a control apparatus and with a harmonic determination module connected to the control apparatus,

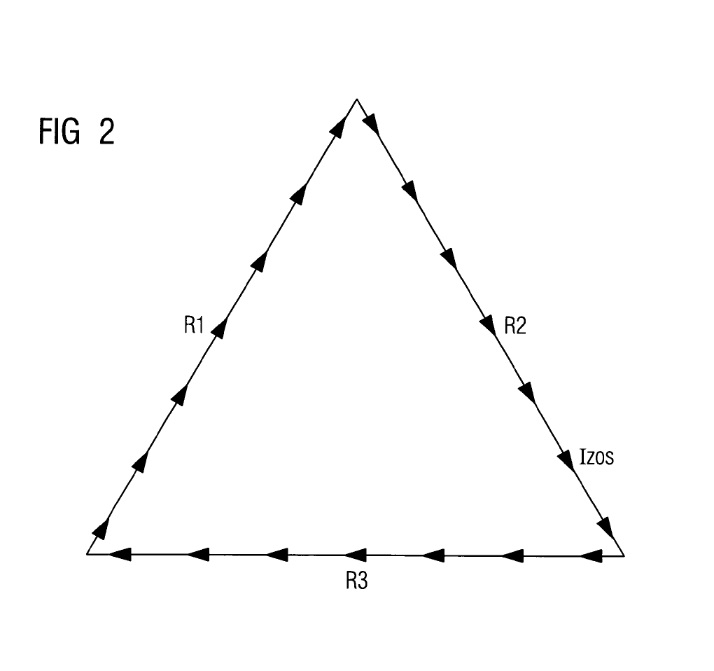

FIG. 2 a schematically illustrated example of the harmonic currents flowing in a closed loop in the converter according to FIG. 1,

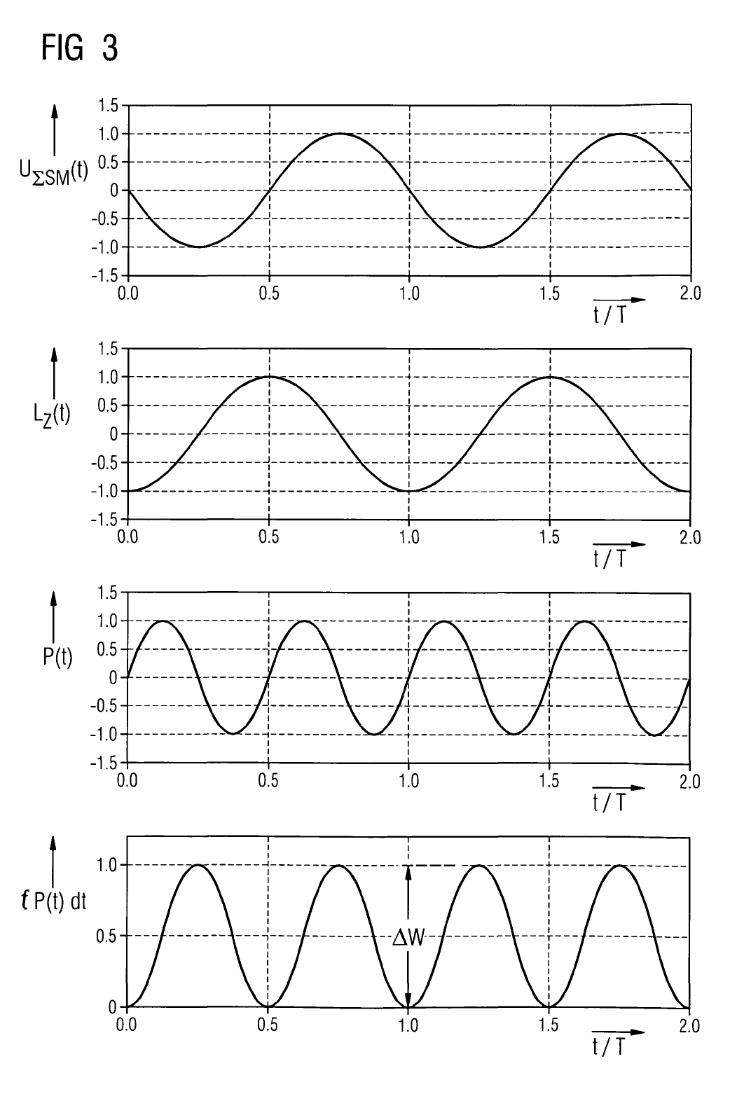

FIG. 3 the currents flowing in the converter according to FIG. 1 and the voltages present when the converter is operated without the harmonic determination module,

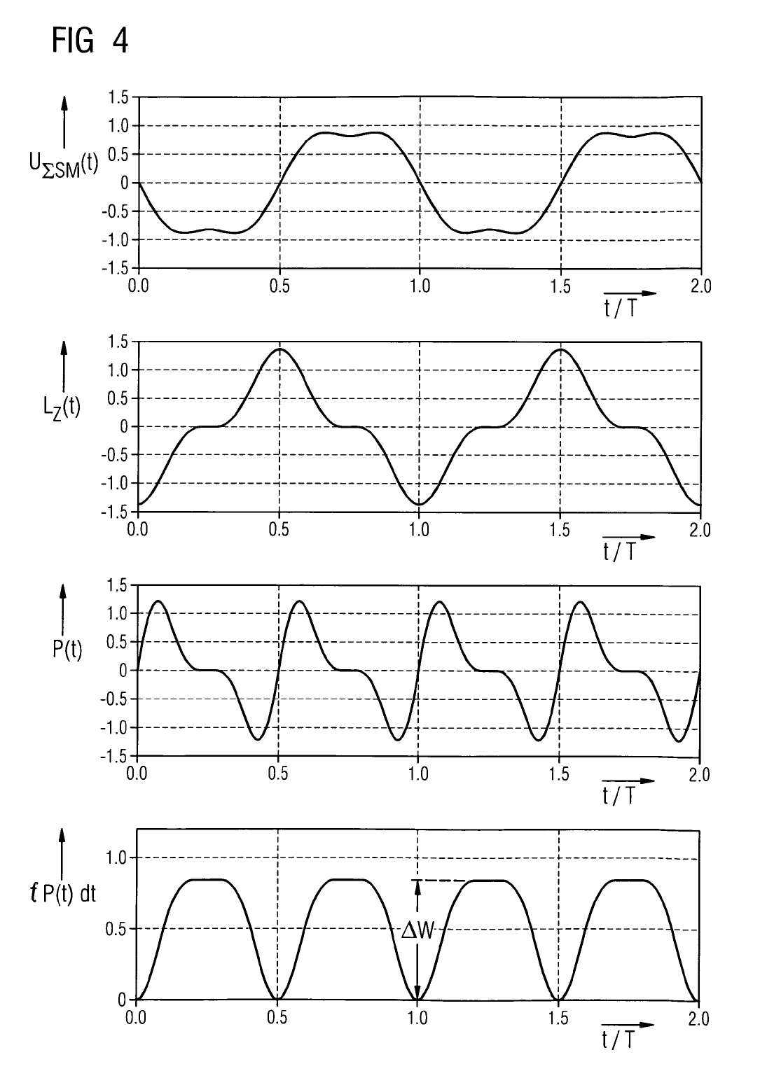

FIG. 4 the currents flowing in the converter according to FIG. 1 and the voltages present during operation of the harmonic determination module, that is to say with the additional harmonic currents flowing in a closed loop,

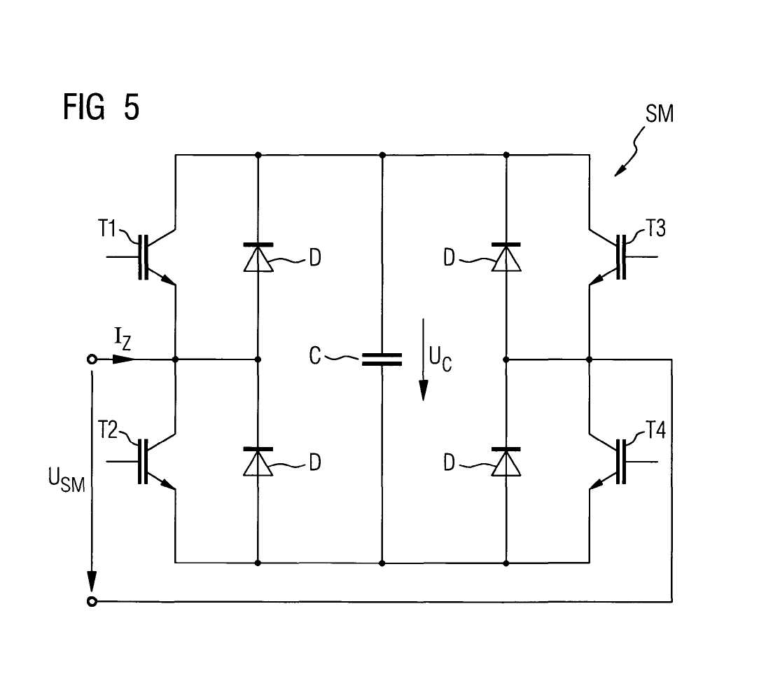

FIG. 5 an exemplary embodiment of a switching module for the converter according to FIG. 1,

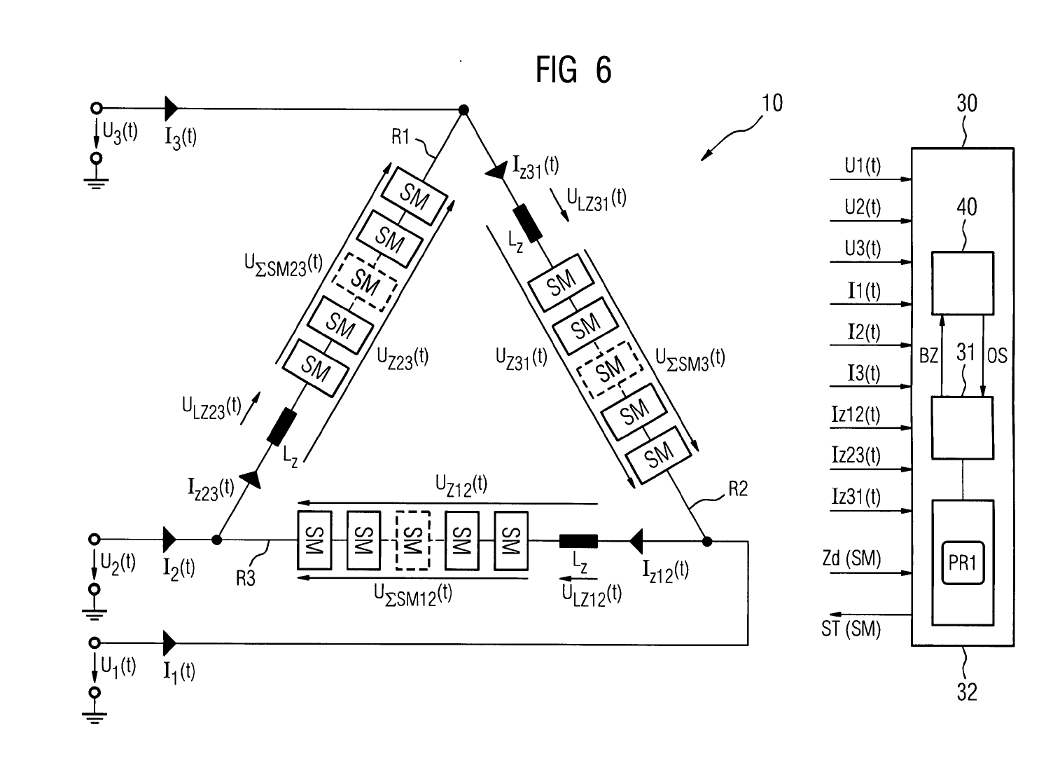

FIG. 6 a second exemplary embodiment of a converter according to the invention, in which the harmonic determination module is implemented in the control apparatus,

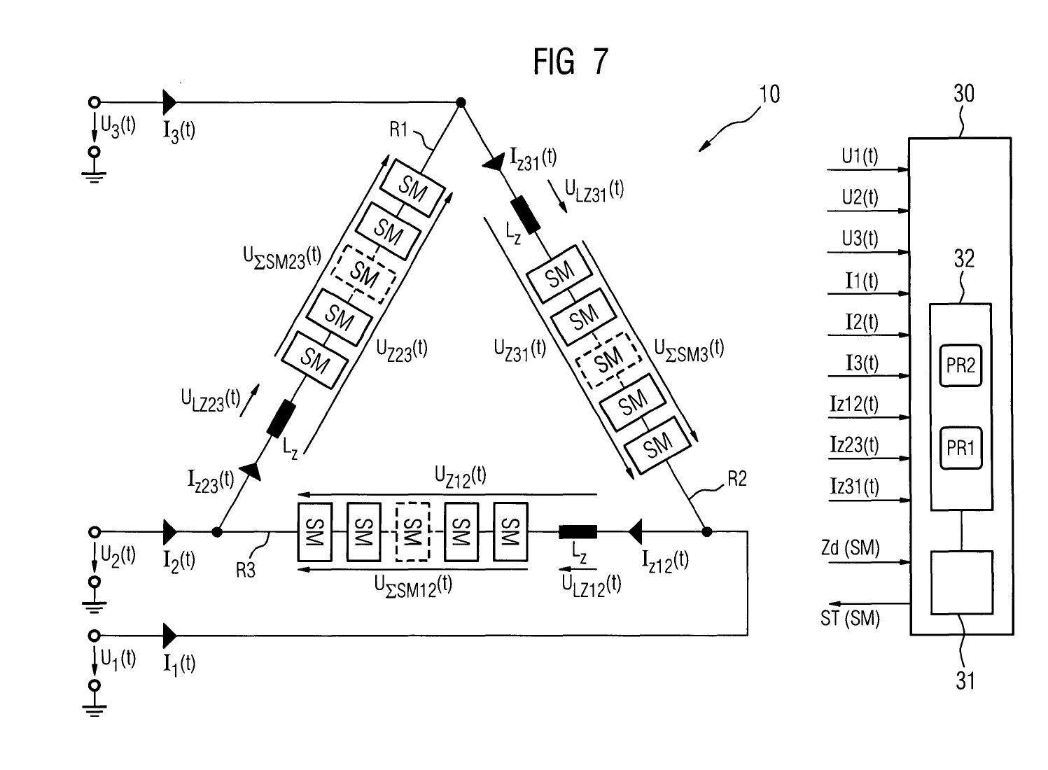

FIG. 7 a third exemplary embodiment for a converter according to the invention, in which the harmonic determination module is constituted by a software program module, and

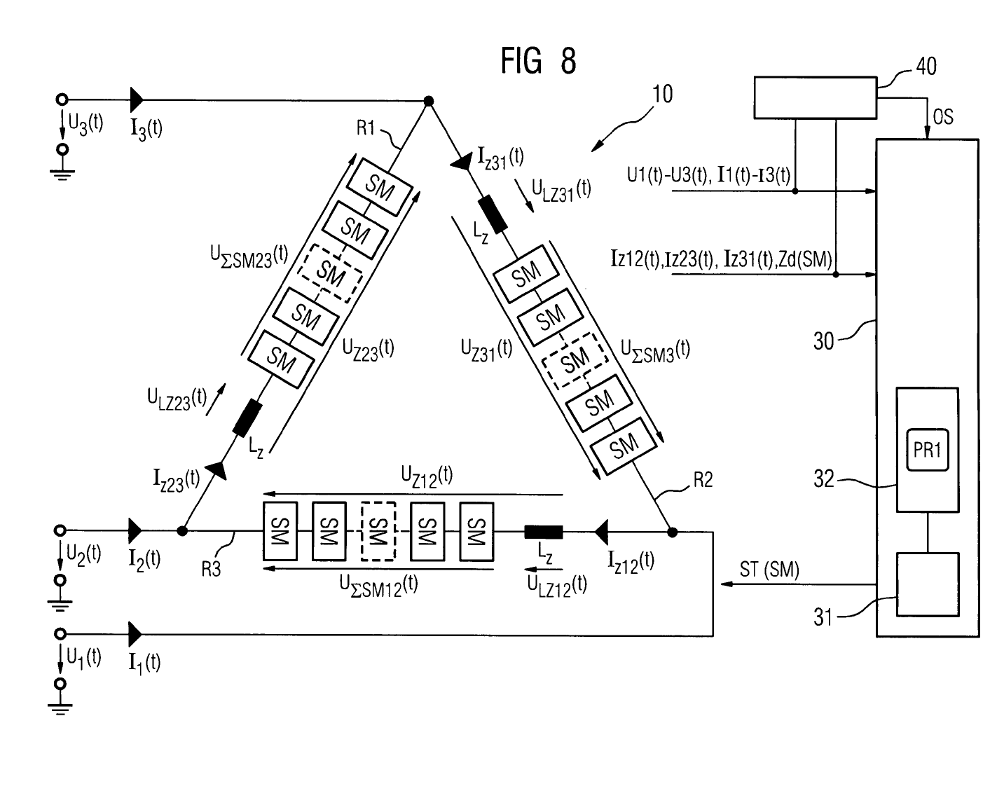

FIG. 8 a fourth exemplary embodiment for a converter according to the invention, in which the harmonic determination module directly processes measurement signals or measured data.

For the sake of clarity, the same reference codes have always been used in the figures for identical or comparable components.

FIG. 1 shows a three-phase converter 10 for a three-phase voltage. The phase voltages of the three-phase voltage are identified in FIG. 1 with the references U1(t), U2(t) and U3(t). The phase currents flowing as a result of the phase voltages U1(t), U2(t) and U3(t) are identified with the references I1(t), I2(t) and I3(t).

The converter 10 comprises three delta-connected series circuits R1, R2, R3, each of which comprises at least two switching modules SM connected in series and an inductance L.

The switching modules SM are connected to a control apparatus 30, which can operate the switching modules SM by means of individual switching module control signals ST(SM) such that branch currents Iz12(t), Iz31(t) and Iz23(t) with the fundamental frequency of the three-phase voltage and with additional harmonic currents flow in the series circuits R1, R2, R3. As explained further below in more detail, the additional harmonic currents can be dimensioned such that they flow in the series circuits R1, R2, R3 of the converter 10 in a closed loop, and remain inside the converter 10, and do not flow into the phase currents I1(t), I2(t) and I3(t).

To form the additional harmonic currents, the converter 10 comprises a harmonic determination module 40 which determines at least one additional current harmonic for each of the series circuits R1, R2, R3 on the basis of the converter operating state at the time.

The control apparatus 30 is connected via individual control lines to each of the switching modules SM of the three series circuits R1, R2 and R3. The connecting lines are not illustrated in FIG. 1 for reasons of clarity. In order to operate the switching modules SM, the control apparatus 30 generates the control signals ST(SM), which are transmitted to the switching modules via the control lines that are not shown.

In order to determine the optimum control signals ST(SM), the input side of the control apparatus 30 is supplied with a large number of measurement signals and/or measured data which represent the alternating voltages U1(t), U2(t) and U3(t), the phase currents I1(t), I2(t) and I3(t) flowing, and/or the branch currents Iz12(t), Iz23(t) and Iz31(t) present in the converter.

In addition, the control apparatus 30 is connected—for example via the control lines already explained, or via other signal lines—to the switching modules SM of the three series circuits R1, R2 and R3 such that the state data Zd(SM) describing the respective state of the switching modules can be transmitted to the control apparatus 30.

The control apparatus 30 thus knows, on the basis of the data present at the input side, what voltages and currents are present, as well as which operating state the individual switching modules SM of the three series circuits R1, R2, R3 are in.

On the basis of the measurement signals and/or measured data present at the input side, and of the state data present at the input side, the control apparatus 30 is in a position to operate the switching modules SM such that a desired converter behavior, for example a desired compensation behavior, in particular a desired behavior compensating for reactive power, harmonics or flicker, is achieved.

In order to be able to perform the described control tasks, the control apparatus 30 can, for example, comprise a computing apparatus (e.g. in the form of a data processing installation or of a computer) 31, which is programmed such that, depending on the measurement signals, measured data and/or state data present at the input side, it determines the respective optimum operation of the switching modules SM, and in this way generates the control signals ST(SM) necessary for the operation. An appropriate control program (or control program module) PR1 for operation of the computing apparatus can be stored in a memory 32 located in the control apparatus 30.

The harmonic determination module 40 already described receives operating state data BZ describing the operating state of the converter 10 from the control apparatus 30 via a control line. Depending on the operating state data BZ, the harmonic determination module 40 generates harmonic content data OS which defines, for each of the three series circuits R1, R2 and R3, at least one additional current harmonic that is also to flow in each of the respective series circuits R1, R2 and R3.

The control apparatus 30 processes the harmonic content data OS received from the harmonic determination module 40, and modifies the operation of the switching modules SM of the series circuits R1, R2 and R3 by means of the control signals ST(SM) such that not only the corresponding branch currents that are necessary for the desired converter behavior flow in the series circuits, but also the additional harmonic currents that have been determined by the harmonic determination module 40.

The magnitude and phase of the additional harmonic currents determined by the harmonic determination module 40 are dimensioned such that the additional harmonic currents flow in a closed loop in the three series circuits R1, R2 and R3. This is illustrated schematically in FIG. 2.

It can be seen in FIG. 2 that the additional harmonic currents Izos only flow in the three series circuits R1, R2 and R3, and do not leave the converter.

The additional harmonic currents Izos are superimposed on the branch currents “necessary” for operation of the converter 10 in the series circuits R1, R2 and R3 such that the energy swing ΔW in each of the three series circuits R1, R2 and R3 is smaller than would be the case without the additional harmonic currents Izos. This is illustrated in detail in FIGS. 3 and 4.

In FIGS. 3 and 4, the variable U_{Σ}sm(t) indicates the example of the voltage at one of the switching module groups of one of the series circuits R1, R2 or R3, Iz(t) the branch current flowing through the corresponding switching module group, P(t) the power resulting in the respective switching module group, and ∫P(t)dt the corresponding integral of the power, from which the respective energy swing ΔW results.

FIG. 3 shows the waveforms without the additional harmonic currents Izos, i.e. the case in which only the corresponding branch currents necessary for the conversion flow in the series circuits R1, R2 and R3.

FIG. 4 shows the waveforms for the identical operating point with the additional harmonic currents Izos, i.e. the case in which the harmonic currents are modulated onto the branch currents through an appropriate operation of the switching modules SM. It can be seen that, due to the additional harmonic currents, the energy swing ΔW is smaller than is the case without the corresponding harmonic currents (cf. FIG. 3).

FIG. 5 shows an exemplary embodiment of a switching module SM. The switching module SM comprises four transistors T1-T4, four diodes D and a capacitor C across which a capacitor voltage Uc is dropped. For operation, one of the transistors (in this case transistor T2) is subjected to a control voltage U_{SM} by the control apparatus 30 according to FIG. 1.

The way in which the harmonic determination module 40 according to FIG. 1 works will now be explained in more detail:

In the quasi-stationary state, the energy swing ΔW depends only on the frequency and amplitude of the alternating voltage system and on the phase angle, frequency and amplitude of the currents in the alternating voltage system. For the series circuit R1 in FIG. 1 in the case of being used, for example, purely as a reactive power compensator, and neglecting the converter losses:

ΔW=max|∫P(t)dt|min|∫P(t)dt| (1)

where

P(t)=U_{ΣSM12}(t)·I_{Z12}(t), (2)

I_{Z12}(t)=−Î_{Z12}·sin(ω·t+φ), (3)

$${U}_{\sum SM 12} ( t ) = {\hat{U}}_{Z 12} \cdot sin ( ω \cdot t ) - {L}_{Z} \cdot ( {\hat{I}}_{Z 12} \cdot cos ( ω \cdot t + \frac{π}{2} ) \cdot ω ) \qquad ( 4 )$$

When all the branches of the converter are in the symmetrical, quasi-stationary state, the energy pulsation described is identical, although having different phases. A pulsation in the difference between the energies of two branches, the “branch energy difference”, is the result. The variation of the energy difference between two branches over time then depends directly on the variation over time of the energy of one branch and on the phase shift of the voltages and currents at the alternating voltage tap of the branch.

The temporal mean of the energy stored in a branch is preferably distributed evenly over the capacitors of the switching modules of the branch concerned. This keeps the voltages across the switching module capacitors of a branch approximately equal.

The individual capacitors are here specified for a specific maximum voltage Umax. From this follows a maximum energy Wmax that can be stored in the branch, which depends on the number of the submodules N in the branch and on the capacitance C of the individual submodules.

$${W}_{max} = N \cdot \frac{C}{2} \cdot {( {U}_{C , max} )}^{2} \qquad ( 5 )$$

If the maximum energy Wmax is exceeded, the converter must be switched off due to the risk of being destroyed.

A lower limit for the branch energy also exists, which follows from the voltage U_{ΣSM}(t) to be provided by the module stack.

$${W}_{min} ( t ) = \frac{{( {U}_{\sum SM} ( t ) \cdot \frac{1}{k} )}^{2}}{N} \cdot \frac{C}{2} , \\ with k < 1 for all t \qquad ( 6 )$$

The duty cycle k is necessarily smaller than one, its concrete value following from the quality of the converter's regulation and from the requirements of its regulating behavior. If the energy falls below minimum, the converter is no longer capable of regulation.

If short circuits or other faults occur at the terminals of the converter, the individual branches must absorb or give out a high quantity of energy. This property follows from the requirements of the connected networks or installations for the high currents that result to be handled in accordance with requirements.

The minimum energy Wₘᵢₙ₊ᵣₑₛ of a branch is thereby predetermined, and corresponds to the minimum branch energy Wₘᵢₙ necessary to maintain the capacity for regulation, plus the amount of energy W_{res,neg} that must be supplied in the worst case in the event of a fault.

Wₘᵢₙ₊ᵣₑₛ=WₘᵢₙW_{res,neg} (7)

The maximum energy that must be stored in one branch of the converter, Wₘₐₓ, is also physically predetermined. It is, firstly, the sum of the minimum energy Wₘᵢₙ₊ᵣₑₛ mentioned above and the maximum energy swing ΔWₘₐₓ that will occur in normal operation. The reserve energy W_{res,pos} required for fault cases that increase the branch energy must be added to this:

Wₘₐₓ=ΔWₘₐₓ+Wₘᵢₙ₊ᵣₑₛ+W_{res,pos} (8)

As already explained above, the individual capacitors in the switching modules of the converter branches are specified for a particular maximum voltage U_{C,max}. A maximum energy that can be stored in the branch, depending on the number of switching modules N in the branch, follows from this. N and the capacitance of the switching module capacitors C must here satisfy the rule that the branch energy occurring in operation, or in the event of a converter fault, is always smaller than the maximum amount of energy that can be stored in the branch:

$${W}_{max} = Δ {W}_{max} + {W}_{min + res} + {W}_{res , pos} \leq N \cdot \frac{C}{2} \cdot {( {U}_{C , max} )}^{2} \qquad ( 9 )$$

If this condition is not observed, the converter must be switched off, since otherwise it would be destroyed.

It should be noted that this specifies the minimum number of modules and module capacitance of the converter for the specified operation with the maximum energy swing. If the maximum energy swing is reduced, as is achieved through the harmonic determination module 40, a reduction in the number of modules in each branch of the converter, and a reduced installation effort, can thus be achieved.

In the converter, moreover, one of the branch currents flows through every installed switching module. The reduction in the number of modules therefore also permits a corresponding reduction in the losses of the converter.

As a side-effect, moreover, a reduction in the number of modules can also have a positive effect on the distribution of the conduction losses of the semiconductors in the individual switching modules, so permitting slightly higher branch currents—i.e. higher converter performances.

In order to generate the described harmonics flowing in a closed loop, harmonic currents, preferably divisible by three (in respect of the frequency of the alternating current system to which the converter is attached in accordance with FIG. 1), are impressed onto the branch currents. They constitute a common-mode component, and thus have identical effects on all the branches. Harmonic currents are preferably generated for the third and ninth harmonics.

The formulas given above apply as follows for stationary operation of the converter, for example as a pure reactive power compensator (assuming that the third current harmonic is employed, and neglecting converter losses):

$$\begin{matrix}{I}_{Z 12} ( t ) = {\hat{I}}_{Z 12} \cdot sin ( ω \cdot t + \frac{π}{2} ) + {\hat{I}}_{3} \cdot sin ( 3 \cdot ω \cdot t + {ϕ}_{3} ) & ( 10 ) \\ {U}_{\sum SM 12} ( t ) = {\hat{U}}_{Z 12} \cdot sin ( ω \cdot t ) - {L}_{Z} \cdot ( {\hat{I}}_{Z 12} \cdot cos ( ω \cdot t + \frac{π}{2} ) \cdot ω + {\hat{I}}_{3} \cdot cos ( 3 \cdot ω \cdot t + {ϕ}_{3} ) \cdot 3 \cdot ω ) & ( 11 )\end{matrix}$$

Through the careful selection of the amplitude and phase of one or more of the said harmonics, the change in power over time of each converter branch can thus be changed such that the resulting energy swing is smaller than that which would arise without the said harmonics, as is illustrated by way of example in FIGS. 3 and 4. The maximum energy Wₘₐₓ that occurs is thus reduced. As a result the design of the converter can involve a reduced number of series circuits and/or switching module capacitance C, whereby costs and converter losses can be lowered.

The harmonics that must be impressed in order to reduce the energy swing can be determined in a variety of ways. Control by means, for example, of a characteristic map which reads and accordingly injects the optimum harmonic parameters depending on the current state of the converter is a possibility. The said characteristic map can be prepared in a variety of ways (e.g. through analytic computation, numerical optimization etc.). Alternatively—for example for dynamic processes—a regulation system can be provided which automatically regulates the appropriate harmonics.

The method described for calculating and generating the harmonics that are to be additionally impressed can be performed independently of the otherwise usual regulation or control method for power, voltage, current, and energy balance, in the same way that the control or regulation is done in the exemplary embodiment according to FIG. 1 by the control program PR1, because the harmonics are superimposed on the “normal” branch currents, which are calculated by the control program PR1 in FIG. 1, and the harmonics that are modulated on do not affect the magnitudes and balance relationships regulated by the control program PR1.

The determination and/or generation of the harmonics can equally be implemented as an integral component of the said regulation/control system.

No additional expense thus arises in the power section of the converter (measuring apparatus etc.) to implement the harmonic generation. It can, for example, be implemented in software, and could even be retrofitted to plants that already exist without changes to the hardware.

FIG. 6 shows a second exemplary embodiment of a converter 10 according to the invention. The converter according to FIG. 6 corresponds in its function to the converter according to FIG. 1. In contrast to that, the harmonic determination module 40 is implemented in the control apparatus 30.

FIG. 7 shows a third exemplary embodiment of a converter 10 according to the invention, in which the harmonic determination module 40 is formed by a software program module PR2 which is stored in the memory 32 of the computing apparatus 31 of the control apparatus 30. In order to determine the harmonic content data, or for determination of the additional harmonic currents that are necessary or advantageous for a reduction of the energy swing in the series circuits R1, R2 and R3, the computing apparatus 31 of the control apparatus 30 merely has to call and execute the software program module PR2.

FIG. 8 shows a fourth exemplary embodiment of a converter 10 according to the invention, in which the harmonic determination module 40 directly processes the measurement signals or measured data which are also processed by the control apparatus 30. The harmonic determination module 40 can thus operate independently of the operating state data which is provided by the control apparatus 30. In addition, the method of operation of the harmonic determination module 40 and of the converter 10 corresponds as a whole to the method of operation of the converter 10 according to FIG. 1.

The harmonics described above can be modulated on both in the stationary state and during transient processes (e.g. in the event of a fault). Due to the greater ease of mathematical representation, the quasi-stationary state was shown in the abovementioned computation examples. The possibility of impressing the harmonics in the transient case is nevertheless included in the considerations described.

Although the invention has been illustrated and described in detail more closely through the preferred exemplary embodiments, the invention is not restricted by the disclosed examples, and other variations can be derived from it by the expert without departing from the scope of protection of the invention.

1-10. (canceled)

11. A converter for three-phase voltage, the converter comprising:
three delta-connected series circuits each having at least two switching modules connected in series; and
a control apparatus connected to said switching modules and operating said switching modules such that branch currents with a fundamental frequency of the three-phase voltage and with at least one additional current harmonic flow in said delta-connected series circuits, wherein the additional current harmonic dimensioned such that the additional current harmonic flows in a closed loop in said delta-connected series circuits of the converter, and remains within the converter.

12. The converter according to claim 11, wherein the converter is a compensator.

13. The converter according to claim 11,
further comprising a harmonic determination module for determining the at least one additional current harmonic on a basis of a converter operating state at a time, wherein the additional current harmonic is dimensioned such that the additional current harmonic flows in the closed loop in said delta-connected series circuits of the converter and remains within the converter; and
wherein said control apparatus operates said switching modules such that the at least one additional current harmonic determined by said harmonic determination module flows in said delta-connected series circuits.

14. The converter according to claim 11, wherein a magnitude and phase of additional harmonic currents are dimensioned such that an energy swing in each of said delta-connected series circuits is smaller than without the additional harmonic currents.

15. The converter according to claim 11, wherein each of said switching modules contains at least four transistors and a capacitor.

16. The converter according to claim 11, wherein the converter is a compensator for reactive power, harmonics or flicker.

17. A method for operating a converter for three-phase voltage and having three delta-connected series circuits, each of the delta-connected series circuits has at least two switching modules connected in series, which comprises the steps of:
operating the switching modules such that branch currents with a fundamental frequency of the three-phase voltage and with a specified magnitude and/or a specified waveform flow in the delta-connected series circuits;
determining at least one additional current harmonic on a basis of a converter operating state at a time, wherein the additional current harmonic is dimensioned such that the additional current harmonic flows in a closed loop in the delta-connected series circuits of the converter and remains inside the converter; and
operating the switching modules such that the at least one additional current harmonic determined at the time flows in the delta-connected series circuits.

18. The method according to claim 17, which further comprises dimensioning a magnitude and phase of additional harmonic currents such that an energy swing in each of the delta-connected series circuits is smaller than without the additional harmonic currents.

19. The method according to claim 17, wherein at least one harmonic current, whose frequency corresponds to a multiple, divisible by three, of the fundamental frequency or mains frequency of the three-phase voltage, are impressed onto the branch currents of the delta-connected series circuits.

20. The method according to claim 17, wherein at least one harmonic voltage is impressed into the converter, whose frequency corresponds to a harmonic, divisible by three, of the fundamental frequency or mains frequency of the three-phase voltage.

21. The method according to claim 17, which further comprises performing a compensation with the converter.

22. The method according to claim 17, which further comprises performing a compensation with the converter for reactive power, harmonics or flicker.
